(19) United States
(12) Patent Application Publication
(10) Pub. No.: US 2013/0315575 A1
(43) Pub. Date: Nov. 28, 2013

(54) CONCENTRIC COIL INFRARED EMITTER LAMP

(71) Applicants: Arturo DeSantiago, El Paso, TX (US); Victor Codero, Juarez (MX)

(72) Inventors: Arturo DeSantiago, El Paso, TX (US); Victor Codero, Juarez (MX)

(73) Assignee: OSRAM SYLVANIA INC., Danvers, MA (US)

(21) Appl. No.: 13/478,620

(22) Filed: May 23, 2012

(51) Int. Cl. F26B 3/30; F27D 11/12

(52) U.S. Cl. 392/407

(57) ABSTRACT

An infrared emitter lamp (200) includes a first heating element (214) wound about and supported by an intermediate tubular member (210) and a second heating element (230) wound about and supported by an inner tubular member (226), wherein the inner tubular member (226) and second heating element (230) coupled thereto are disposed within the intermediate tubular member (210). The lamp (200) further includes an outer tubular member (202) enclosing the intermediate and inner tubular members (210, 226) and first and second heating elements (214, 230) coupled thereto. The first heating element (214) is adapted to operate at a first wattage level and the second heating element (230) is adapted to operate at a second wattage level less than the first wattage level.

### FIELD

The present disclosure relates generally to a lamp, and, more particularly, to a concentric coil infrared emitter lamp.

### BACKGROUND

Infrared heater systems may include infrared heat lamp(s) configured to emit infrared radiation, which, in turn, may be used as a deliberate heating source. For example, an infrared heater system may be used to cook and/or heat food and may also be used in industrial manufacturing processes, including, but not limited to curing of coatings, forming of plastics, annealing, plastic welding, and print drying. Additionally, an infrared heater system may be used to heat a surrounding environment, such as one's home or office.

FIG. 1 is an exploded perspective view of a prior art infrared heat lamp, such as one available in the United States from Osram Sylvania Inc. under the designation “J168” rated 500 W 115V and used in portable heaters marketed by EdenPURE®. The infrared heat lamp 100 includes an outer tubular member 102 and a coiled heating element 104 disposed within the outer tubular member 102. The coiled heating element 104 includes a first terminal end 106 and a second terminal end 108. The coiled heating element 104 is wound about an inner tubular member 110, wherein at least a portion of the second terminal end 108 is disposed within the inner member 110 and insulated from other portions of the heat element 104. The outer tubular member 102 is formed from high-temperature resistant and/or insulating material(s), such as quartz tube, ceramic tube, or ceramic enamel tube. The coiled heating element 104 and the inner tubular member 110 are disposed within the outer tubular member 102, whereby the outer tubular member 102 serves as an insulator for the coiled heating element 104. A first end of the outer tubular member 102 is sealed with a first end cap 112 and a second opposing end of the outer tubular member 102 is sealed with a second end cap 114.

When in operation, an electric current passes through the coiled heating element 104 by way of the first and second terminal ends 106, 108, thereby heating and causing the heating element 104 to emit infrared radiation. The infrared heat lamp 100 may be used as a heating source in a heater system, whereby the heater system may direct the infrared radiation emitted from the heat lamp 100 to a desired application.

The power of a heat lamp may limit use of the heat lamp to a particular application. For example, in regards to a heater system for heating one's home, the power of the heat lamp may be limiting in respect to the size of a room that can be adequately heated by the heat lamp (i.e. the lower the power, the smaller the room that can be heated). As such, some heater systems may include multiple heat lamps in order to increase the overall output of the heater system. Additionally, some individual heat lamps may include multiple heating elements within, such as the coiled heating element 104 described above, to increase the overall power of a heat lamp. For example, a heat lamp may include three 500 W heating elements within, each of the elements running independently from one another, and, when in operation, the heat lamp may have a total combined power of 1500 W. Examples of such heat lamps may be found in U.S. Pat. No. 8,014,652 (Suzuki); and U.S. Pat. No. 7,639,930 (Mizukawa).

However, the methods of increasing the power of a heater system or an individual heat lamp, as described above, present disadvantages. In particular, the additional heat lamps included in a heater system necessarily require an increase in the size of the heater system, so as to accommodate the additional heat lamps. Similarly, including additional heating elements in single heat lamp generally requires an increase in size (e.g. length, width, etc.) of the heat lamp in order to accommodate the additional heating elements. An increase in size of a heater system or an individual heat lamp presents obvious disadvantages.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is an exploded perspective view of a prior art infrared heat lamp;

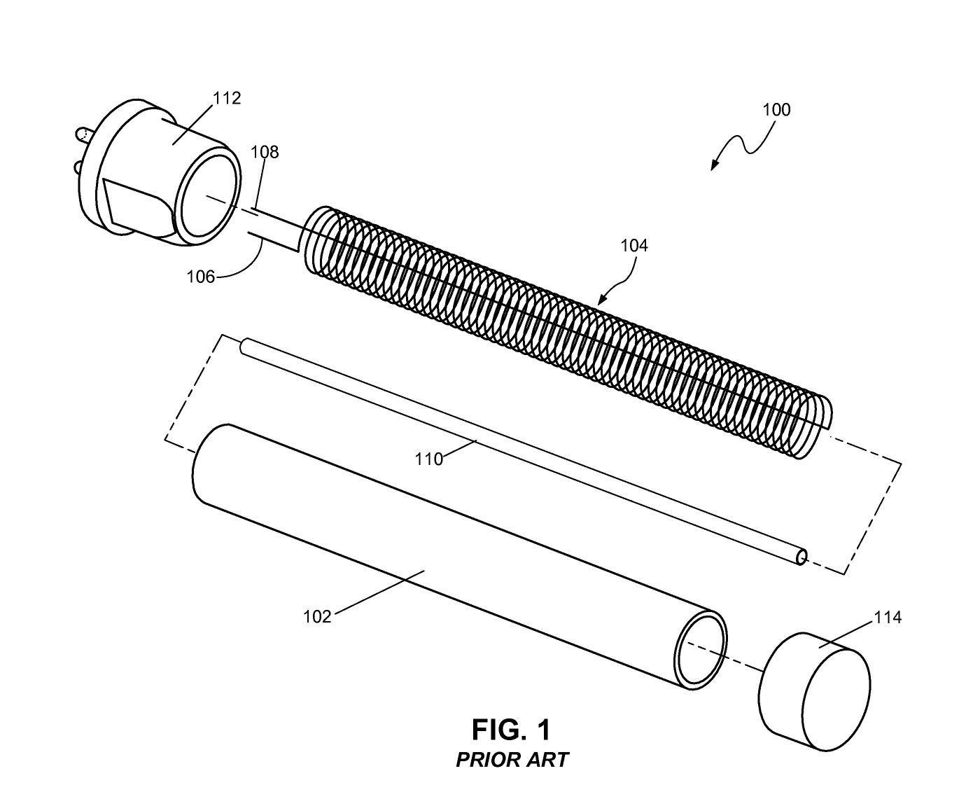

FIG. 2 is an exploded view of an infrared emitter lamp consistent with the present disclosure;

FIG. 3 is a perspective view of the infrared emitter lamp of FIG. 2 showing the emitter lamp in an assembled state;

FIG. 4 is an enlarged perspective view of a portion of the infrared emitter lamp of FIG. 3; and

FIG. 5 is a sectional view of the infrared emitter lamp of FIG. 3 taken along line 5-5.

### DETAILED DESCRIPTION

In general, this disclosure provides an infrared emitter lamp adapted to provide a greater amount of power while having a relatively compact design. The infrared emitter lamp includes a first heating element wound about an intermediate tubular member and a second heating element wound about an inner tubular member and disposed within the intermediate tubular member. The first and second heating elements and associated intermediate and inner tubular members are disposed within an outer tubular member. The first and second heating elements are adapted to emit infrared radiation when electric current is passed there through. The first heating element is adapted to operate at first wattage level and the second heating element is adapted to operate at a second wattage level less than the first wattage level.

An infrared emitter lamp consistent with the present disclosure may allow a greater amount of power output without requiring an increase in size of the lamp to accommodate multiple heating elements. Similarly, an infrared emitter lamp consistent with the present disclosure may be used in a compatible heater system and allow a greater amount of power output of the heater system without requiring multiple heat lamps which would result in an increase in size of the heater system. As such, an infrared emitter lamp consistent with the present disclosure provides a greater amount of power output while providing a compact design and greater concentration of heat.

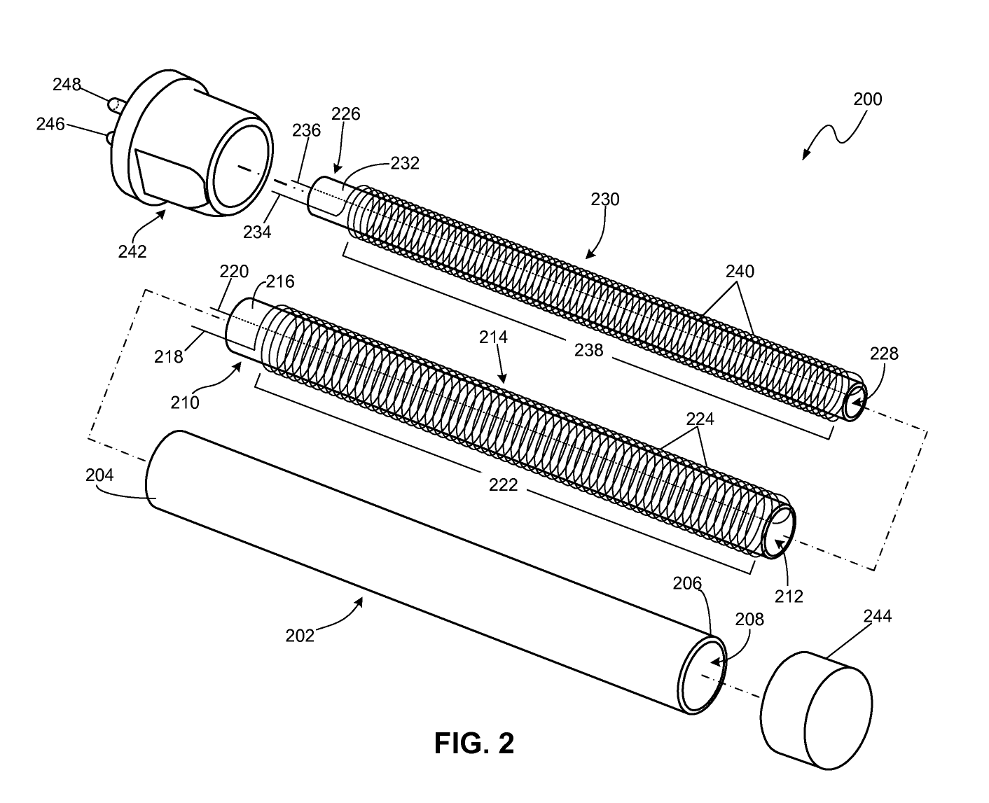

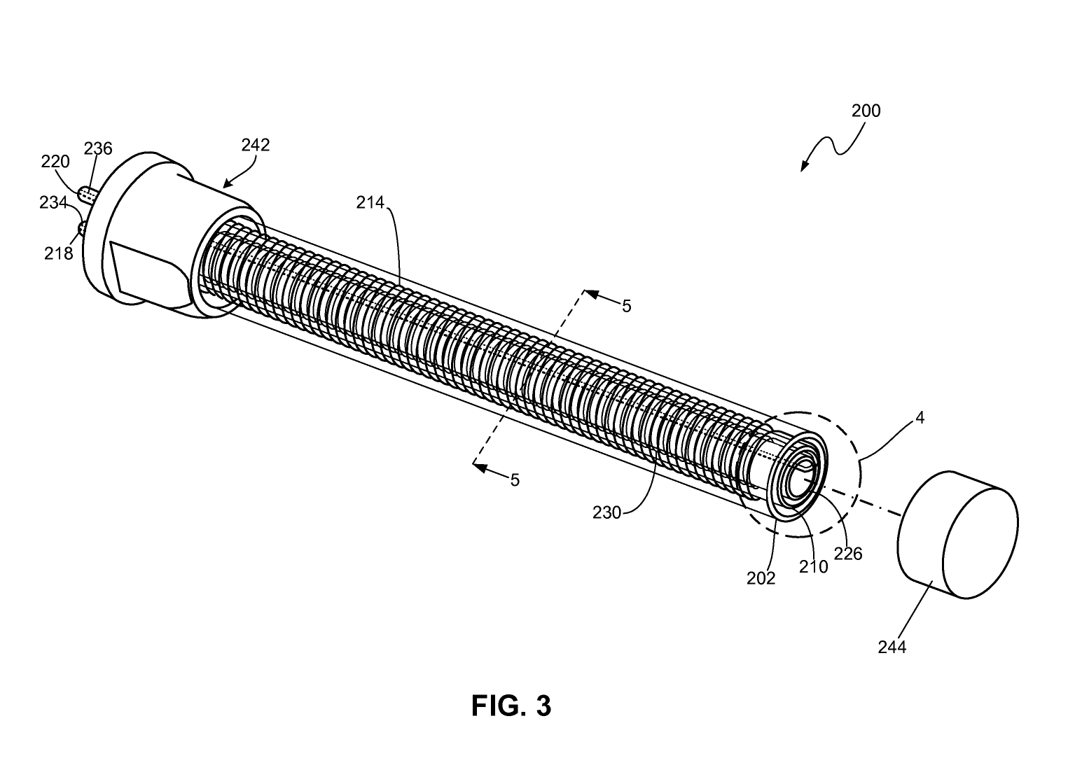

Turning now to the drawings, FIG. 2 is an exploded view of an infrared emitter lamp 200 consistent with the present disclosure and FIG. 3 is a perspective view of the infrared emitter lamp 200 of FIG. 2 showing the emitter lamp 200 in an assembled state. Generally, the infrared emitter lamp 200 includes an outer tubular member 202 and intermediate and inner tubular members 210, 226 supporting first and second heating elements 214, 230, respectively, disposed within the outer tubular member 202. As shown, the outer tubular member 202 has a first end 204 and a second 206 and a passageway 208 extending a length of the member 202 from the first end 204 to the second end 206. The passageway 208 is shaped and/or sized to receive the intermediate and inner tubular members 210, 226 and first and second heating elements 214, 230 within.

As described in greater detail herein, the intermediate and inner tubular members 210, 226 are adapted to provide support and insulation for the first and second heating elements 214, 230. In the illustrated embodiment, the first heating element 214 is wound about an outer surface 216 of the intermediate tubular member 210. The first heating element 214 includes a first terminal end 218 and a second terminal end 220 and a coiled portion 222 defined between the first and second terminal ends 218, 220. The coiled portion 222 includes a plurality of turns 224 wound about the outer surface 216 of the intermediate tubular member 210. As shown, at least a portion of the second terminal end 220 is disposed within a passageway 212 defined within and extending the length of the intermediate tubular member 210. The passageway 212 is adapted to insulate a portion of the second terminal end 220 disposed within from other portions of the first heating element 214, such as, for example, the turns 224 of the coiled portion 222.

Similar to the intermediate tubular member 210 and first heating element 214, the second heating element 230 is wound about an outer surface 232 of the inner tubular member 226. The second heating element 230 includes a first terminal end 234 and a second terminal end 236 and a coiled portion 238 defined between the first and second terminal ends 234, 234. The coiled portion 238 includes a plurality of turns 240 wound about the outer surface 232 of the inner tubular member 226. As shown, at least a portion of the second terminal end 236 is disposed within a passageway 228 defined within and extending the length of the inner tubular member 226. The passageway 236 is adapted to insulate at least portion of the second terminal end 236 disposed within from other portions of the second heating element 230, such as, for example, the turns 240 of the coiled portion 238.

As shown in FIG. 3, when the lamp 200 is in an assembled state, the inner tubular member 226 and second heating element 230 coupled thereto are disposed within the intermediate tubular member 210. More specifically, the passageway 212 of the intermediate tubular member 210 is shaped and/or sized to receive the inner tubular member 226 and second heating element 230 within. When assembled, at least a portion of the second terminal end 220 of the first heating element 214 is disposed within the passageway 228 of the inner tubular member 226, described in greater detail herein.

During operation, an electric current passes through at least one of the first and second heating elements 214, 230 and causes at least one of the first and second heating elements 214, 230 to emit infrared radiation. More specifically, electric current may pass through the first heating element 214 via the first and second terminal ends 218, 220, thereby heating and causing the first heating element 214, specifically the coiled portion 222, to emit infrared radiation. Similarly, electric current may pass through the second heating element 230 via the first and second terminal ends 234, 236, thereby heating and causing the second heating element 230, specifically the coiled portion 238, to emit infrared radiation.

In the illustrated embodiment, the first and second heating elements 214, 230 are electrically coupled to one another and form a parallel electrical circuit such that both the first and second heating elements 214, 230 emit infrared radiation. Although shown in a parallel electrical circuit, it should be noted that the first and second heating elements 214, 230 may form a series electrical circuit. Alternatively, the first and second heating elements 214, 230 may be electrically isolated from one another such that the first and second heating elements 214, 230 operate independently from one another. For example, in one embodiment, the lamp 200 may include a means (e.g. control) of selectively coupling an electric current to only the first heating element 214, only the second heating element 230 or both the first and second heating elements 214, 230 so as to allow multiple configurations (i.e. radiation only the first heating element 214, radiation from only the second heating element 230, radiation from both the first and second heating elements 214, 230).

The first and second heating elements 214, 230 each include a single continuous wire, wherein the wire is a flexible, resilient, and durable material configured to be bent and/or shaped into a desired dimension, such as the plurality of turns 224, 240. The first and second heating elements 214, 230 include electrically conductive filament material(s) configured to withstand high temperatures and/or heat, including, but not limited to, tungsten, carbon, alloys of iron, chromium and aluminum, and/or combinations thereof. For example, the first and second heating elements 214, 230 may each include a heating alloy containing iron-chromium-aluminium (FeCrAl) sold under the trade designation Kanthal® offered by Sandvik Group of Sweden.

The first and second heating elements 214, 230 are adapted to operate at first and second wattage levels, respectively, wherein the second wattage level is level than the first wattage level. Accordingly, the second heating element 230 is adapted to operate at a lower wattage level than the first heating element 214. In one embodiment, the first heating element 214 is adapted to operate at 1000 W and the second heating element 230 is adapted to operate at 500 W, wherein the first and second heating elements 214, 230 operate at a cumulative wattage level of 1500 W. It should be noted that, in other embodiments, the first and second heating elements 214, 230 may each be adapted to operate in a range of wattage levels (e.g. between 500 W and 1000 W).

The heat lamp 200 further includes a first end cap 242 coupled to the first end 204 of the outer tubular member 202 and a second end cap 244 coupled to the second end 206 of the outer tubular member 202. At least one of the first and second end caps 242, 244 includes openings through which the first terminal ends 218, 234 and second terminal ends 220, 236 of the first and second heating elements 214, 230 extend. For example, as shown, the first end cap 242 includes a first opening 246 through which the first terminal ends 218, 234 of the first and second heating elements 214, 230 extend. The first end cap 242 further includes a second opening 248 through which the second terminal ends 220, 236 of the first and second heating elements 214, 230 extend. When fully assembled, as shown in FIG. 3 (second end cap 244 removed to show configuration of tubular members), the first and second end caps 242, 244 are sealed to the outer tubular member 202, thereby enclosing the intermediate and inner tubular members 210, 226 and first and second heating elements 214, 230 within the outer tubular member 202.

The outer tubular member 202 includes a material configured to withstand high temperatures and/or heat and may be transmissive to infrared radiation. In one embodiment, the outer tubular member 202 includes a heat-resistant quartz (fused silica) glass material. Similarly, the intermediate and inner tubular members 210, 226 each include a material configured to withstand high temperatures and/or heat and may be transmissive to infrared radiation. In one embodiment, the intermediate and inner tubular members 210, 226 include a heat-resistant quartz (fused silica) glass material.

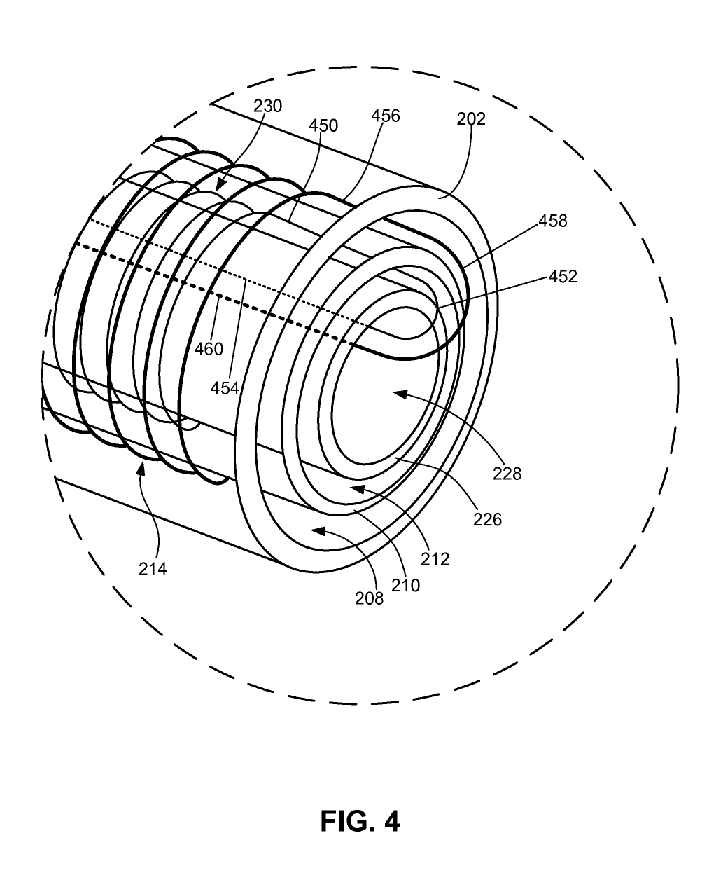

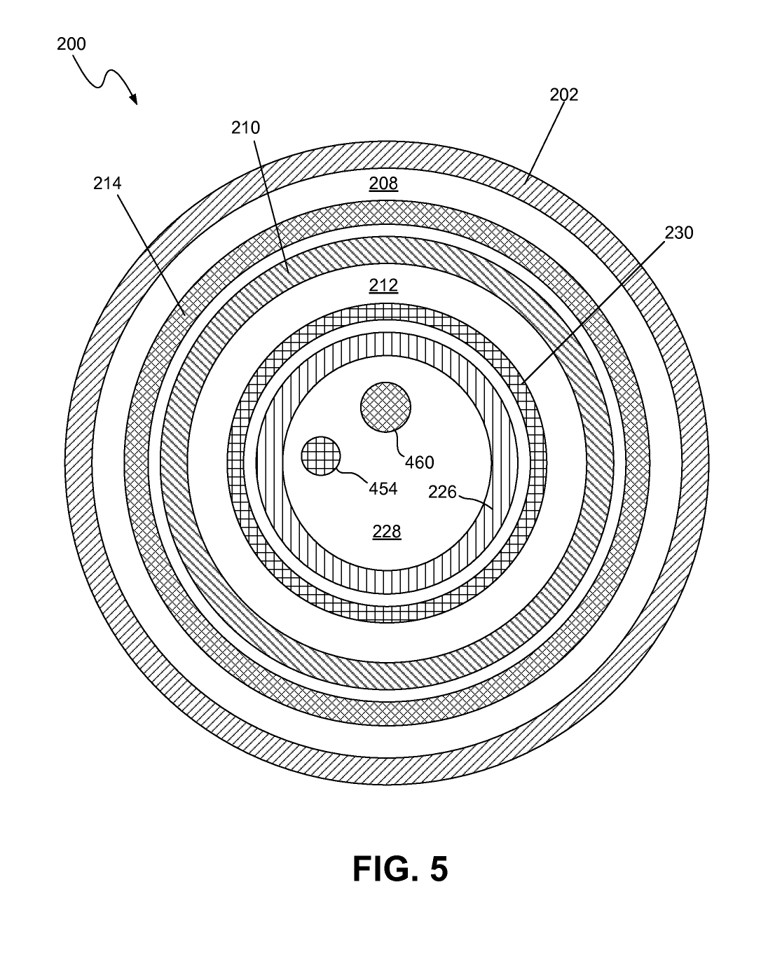

FIG. 4 is an enlarged perspective view of a portion of the infrared emitter lamp 200 of FIG. 3 and FIG. 5 is a sectional view of the infrared emitter lamp 200 of FIG. 3 taken along line 5-5. It should be noted that internal features and/or surfaces are illustrated in phantom in FIG. 4. As shown, when the lamp 200 is assembled, the intermediate tubular member 210 and first heating element 214 are disposed within the passageway 208 of the outer tubular member 202 and the inner tubular member 226 and second heating element 230 are disposed within the passageway 212 of the intermediate tubular member 210.

As previously described, a portion of the second terminal end 236 of the second heating element 230 is disposed within and insulated by the passageway 228 of the inner tubular member 226. As shown, a portion 450 of the second heating element 230 extends from the turns 240 of the coiled portion 238 and forms an arcuate portion 452 bending in direction towards the passageway 228 of the inner tubular member 226. An insulated portion 454 further extends from the accurate portion 452 and through the inner tubular member 226 by way of the passageway 228 and terminates at the second terminal end 236. The first heating element 214 is similarly configured. As shown, a portion 456 of the first heating element 214 extends from the turns 224 of the coiled portion 222 and forms an arcuate portion 458 bending in direction towards the passageway 228 of the inner tubular member 226. An insulated portion 460 further extends from the accurate portion 458 and through the inner tubular member 226 by way of the passageway 228 and terminates at the second terminal end 220.

The inner tubular member 226 is adapted to insulate portions 460,454 of the second terminal end 220, 236 of the first and second heating elements 214, 230 from other portions of the first and second heating elements 214, 230. For example, the passageway 228 separates portion 454 of the second terminal end 236 of the second heating element 230 from the coiled portion 238 and first terminal end 234 to prevent short circuiting and/or other foreseeable issues occurring from unintended contact. Similarly, the passageway 228 separates portion 460 of the second terminal end 220 of the first heating element 214 from the coiled portion 222 and first terminal end 218.

Consistent with one embodiment of the present disclosure, an infrared emitter lamp 200 includes an outer tubular member 202 and an intermediate tubular member 210 and first heating element 214 disposed at least partially within the outer tubular member 210. The first heating element 214 has first and second terminal ends 218, 220 and a coiled portion 222 defined between the first and second terminal ends 218, 220. The coiled portion 222 is wound around at least a portion of an outer surface 216 of the intermediate tubular member 210. The intermediate tubular member 210 provides support and electrical insulation for the first heating element 214.

The infrared emitter lamp 200 further includes an inner tubular member 226 and second heating element 230 disposed at least partially within the intermediate tubular member 210 and the outer tubular member 202. The second heating element 230 has first and second terminal ends 234, 236 and a coiled portion 238 defined between the first and second terminal ends 234, 236. The coiled portion 238 is wound around at least a portion of an outer surface 226 of the inner tubular member 226. The inner tubular member 226 provides support and electrical insulation for the second heating element 230. The first heating element 214 is adapted to operate at a first wattage level and the second heating element 230 is adapted to operate at a second wattage level less than the first wattage level.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

The following is a non-limiting list of reference numerals used in the specification:
100 prior art infrared heat lamp;
102 outer tubular member;
104 heating element;
106 first terminal end of heating element;
108 second terminal end of heating element;
110 inner tubular member;
112 first end cap;
114 second end cap;
200 infrared emitter lamp;
202 outer tubular member;
204 first end of outer tubular member;
206 second end of outer tubular member;
208 passageway of outer tubular member;
210 intermediate tubular member;
212 passageway of intermediate tubular member;
214 first heating element;
216 outer surface of intermediate tubular member;
218 first terminal end of first heating element;
220 second terminal end of first heating element;
222 coiled portion of first heating element;
224 turns of coiled portion of first heating element;
226 inner tubular member;
228 passageway of inner tubular member;
230 second heating element;
232 outer surface of inner tubular member;
234 first terminal end of second heating element;
236 second terminal end of second heating element;
238 coiled portion of second heating element;
240 turns of coiled portion of second heating element;
242 first end cap;
244 second end cap;
246 first opening in first end cap;
248 second opening in first end cap;
450 portion of second heating element extending from coiled portion;
452 arcuate portion of second heating element;
454 insulated portion of second terminal end of second heating element disposed within inner tubular member;
456 portion of first heating element extending from coiled portion;
458 arcuate portion of first heating element; and
460 insulated portion of second terminal end of first heating element disposed within inner tubular member.

What is claimed is:

1. An infrared emitter lamp (200) comprising:
an outer tubular member (202);
an intermediate tubular member (210) and a first heating element (214) disposed at least partially within said outer tubular member (202), said first heating element (214) having first and second terminal ends (218, 220) and a coiled portion (222) defined between said first and second terminal ends (218, 220), said coiled portion (222) being wound around at least a portion of an outer surface (216) of said intermediate tubular member (210), said intermediate tubular member (210) providing support and electrical insulation for said first heating element (214); and
an inner tubular member (226) and a second heating element (230) disposed at least partially within said intermediate tubular member (210) and said outer tubular member (202), said second heating element (230) having first and second terminal ends (234, 236) and a coiled portion (238) defined between said first and second terminal ends (234, 236), said coiled portion (238) being wound around at least a portion of an outer surface (226) of said inner tubular member (226), said inner tubular member (226) providing support and electrical insulation for said second heating element (230);
whereby said first heating element (214) is adapted to operate at a first wattage level and said second heating element (230) is adapted to operate at a second wattage level less than said first wattage level.

2. The infrared emitter lamp of claim 1, wherein a portion (454) of said second terminal end (236) of said second heating element (230) is disposed within said inner tubular member (226).

3. The infrared emitter lamp of claim 1, wherein a portion (460) of said second terminal end (220) of said first heating element (214) is disposed within said intermediate tubular member (210).

4. The infrared emitter lamp of claim 3, wherein said portion (460) of said second terminal end (220) of said first heating element (214) disposed within said intermediate tubular member (210) is disposed within said inner tubular member (226).

5. The infrared emitter lamp of claim 1, wherein said first and said second heating elements (214, 230) comprise an iron-chromium-aluminum alloy material.

6. The infrared emitter lamp of claim 1, wherein said inner and said intermediate tubular members (226, 210) comprise a quartz material.

7. The infrared emitter lamp of claim 1, wherein said first and said second heating elements (214, 230) comprise electrical resistance filaments configured to emit infrared radiation when electric current is coupled to and passed through one of said first and second terminal ends (218, 220), (234, 236) of said first and said second heating elements (214, 230), respectively.

8. The infrared emitter lamp of claim 7, wherein said inner, intermediate and outer tubular members (226, 210, 202) are transmissive to infrared radiation.

9. The infrared emitter lamp of claim 1, wherein said first and said second heating elements (214, 230) are electrically coupled to one another and form a parallel electrical circuit.

10. The infrared emitter lamp of claim 1, wherein said first and said second heating elements (214, 230) are electrically coupled to one another and form a series electrical circuit.

11. The infrared emitter lamp of claim 1, further comprising first and second end caps (242, 244) coupled to first and second ends (204, 206) of said outer tubular member, respectively.

12. The infrared emitter lamp of claim 11, wherein one of said first and second end caps (242, 244) has a first opening (246) through which at least one of said first terminal ends (218, 234) of said first and said second heating elements (214, 230) extends.

13. The infrared emitter lamp of claim 11, wherein one of said first and second end caps (242, 244) has a second opening (248) through which at least one of said second terminal ends (220, 236) of said first and said second heating elements (214, 230) extends.

14. The infrared emitter lamp of claim 1, wherein said first and said second heating elements (214, 230) are adapted to operate at a cumulative wattage level of 1500 watts.

15. The infrared emitter lamp of claim 14, wherein said first wattage level of said first heating element (214) is 1000 watts and said second wattage level of said second heating element (230) is 500 watts.
